(19) United States
(12) Patent Application Publication
(10) Pub. No.: US 2016/0360803 A1
(43) Pub. Date: Dec. 15, 2016

(54) Illuminating and Reflective Safety Patrol Band

(71) Applicant: Edmond Bell, Sr., Los Angeles, CA (US)

(72) Inventor: Edmond Bell, Sr., Los Angeles, CA (US)

(21) Appl. No.: 15/180,808

(22) Filed: Jun. 13, 2016

Related U.S. Application Data
(60) Provisional application No. 62/174,317, filed on Jun. 11, 2015.

(51) Int. Cl. A41D 13/01; F21V 23/02

(52) U.S. Cl. CPC A41D 13/01; F21V 23/02

(57) ABSTRACT

An illuminating and reflective safety patrol band is a garment that is worn to improve the user's visibility in low-light conditions. The garment includes a wearable strap featuring a waist loop and a cross strap that are worn on the body. At least one reflective strip is able to reflect light away from the user's body while at least one illuminating device is able to provide illumination in order to active improve the user's visibility. At least one control unit is utilized to configure the brightness and behavior of the at least one illuminating device. A power supply provides electrical power to the electronic components including a processor for the at least one control unit. At least one securing fastener is utilized to secure the wearable strap to the user's waist in order to prevent the wearable strap from shifting.

The current application claims a priority to the U.S. Provisional Patent application Ser. No. 62/174,317 filed on Jun. 11, 2015. The current application is filed on Jun. 13, 2016 while Jun. 11, 2016 was on a weekend.

### FIELD OF THE INVENTION

The present invention relates generally to a wearable garment for improving the user's visibility. More specifically, the present invention is an illuminating and reflective safety patrol band that is utilized to improve the user's visibility, particularly in low-light conditions.

### BACKGROUND OF THE INVENTION

One of the common dangers associated with outdoor activities in night conditions is the lack of visibility. This is particularly dangerous when running, walking, or bicycling outdoors when visibility conditions are poor as motor vehicle operators may find it difficult to see. Vehicle-related incidents may result in serious injury or death of pedestrians and bicyclists alike. In addition to recreational activities, infrastructure construction and maintenance is often performed in the nighttime. While work areas are often brightly lit and visible, individual workers may be difficult to see at night, presenting a possible hazard for the workers. Nighttime safety is most often improved by wearing brightly colored or reflective clothing. However, this type of clothing is often ineffective as the clothing may not be effective in drawing the attention of motorists or others nearby.

The present invention is an illuminating and reflective safety patrol band that is worn to improve the user's visibility in low-light conditions. The present invention is able to increase the user's visibility actively and passively via illumination and reflection, respectively. The present invention is portable and may be easily worn over and secured to the user's clothing. The user may regulate and control the illumination provided by the present invention as well based on his or her needs.

### BRIEF DESCRIPTION OF THE DRAWINGS

FIG. 1 is a front top perspective view of the present invention.

FIG. 2 is a rear bottom perspective view of the present invention.

FIG. 3 is a front view of the present invention.

FIG. 4 is a rear view of the present invention.

FIG. 5 is a diagram of the electronic components of the present invention.

FIG. 6 is a front top perspective view of the present invention with the at least one control unit removed from the wearable strap.

FIG. 7 is a front top perspective view of the present invention with the cross strap removed from the waist loop.

FIG. 8 is a front top perspective view of the present invention with the at least one control unit positioned on the waist loop.

### DETAIL DESCRIPTIONS OF THE INVENTION

All illustrations of the drawings are for the purpose of describing selected versions of the present invention and are not intended to limit the scope of the present invention.

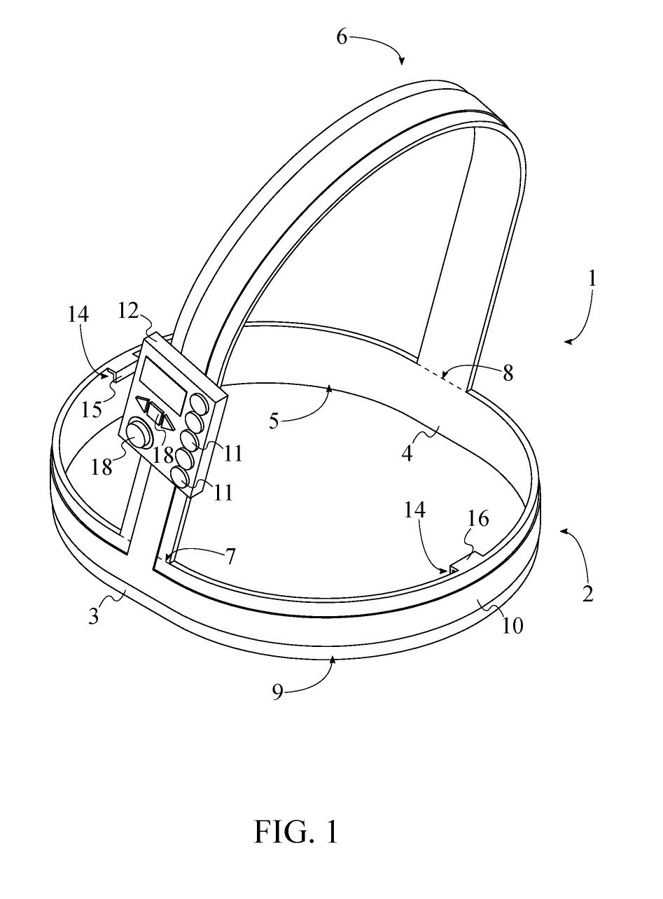

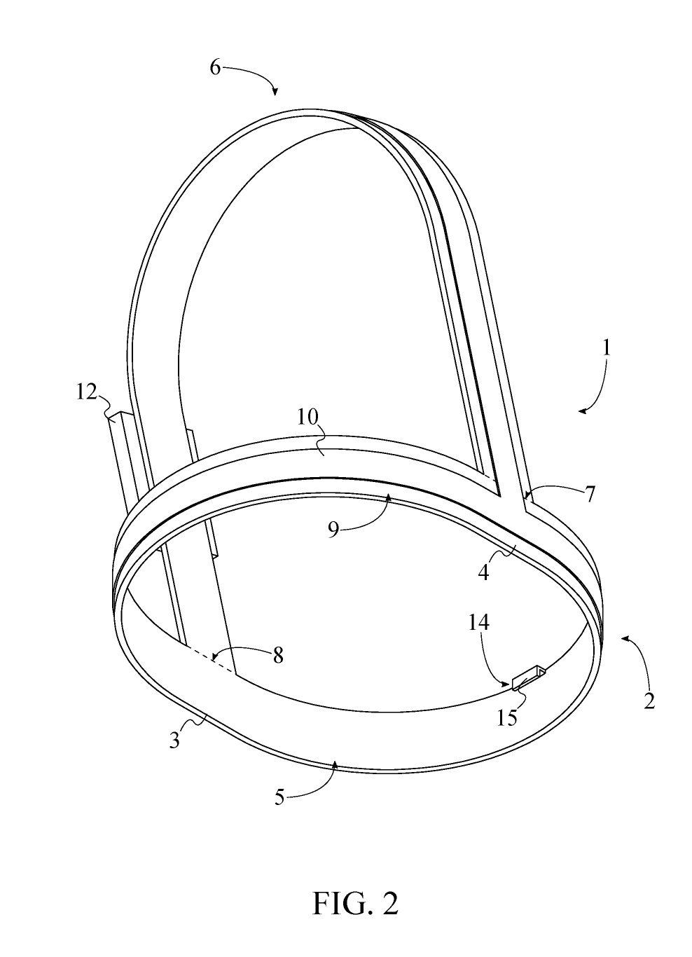

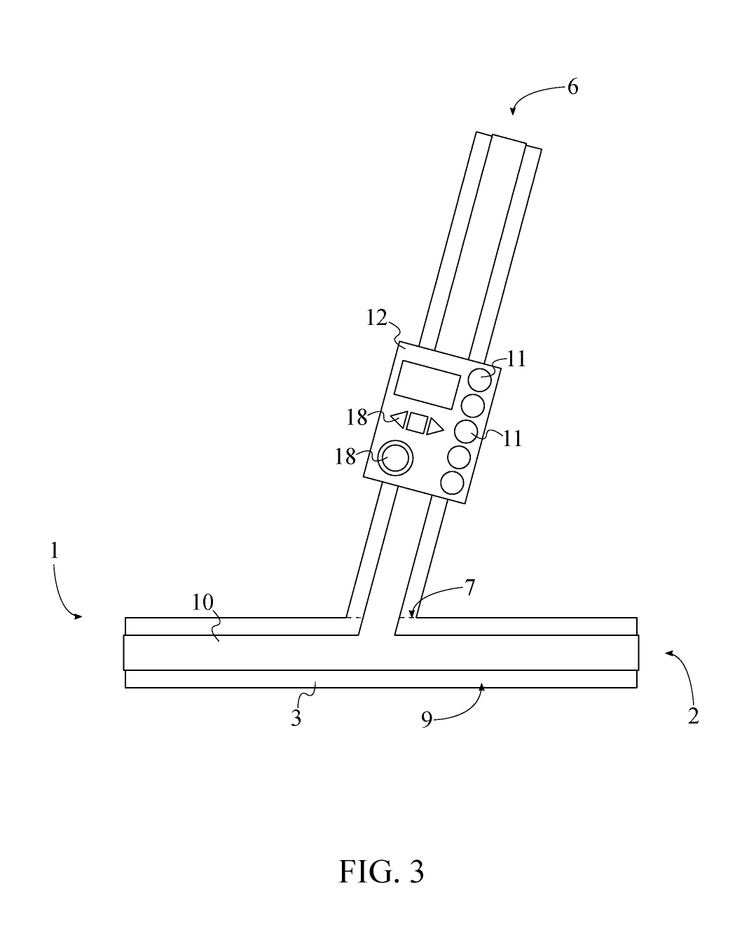

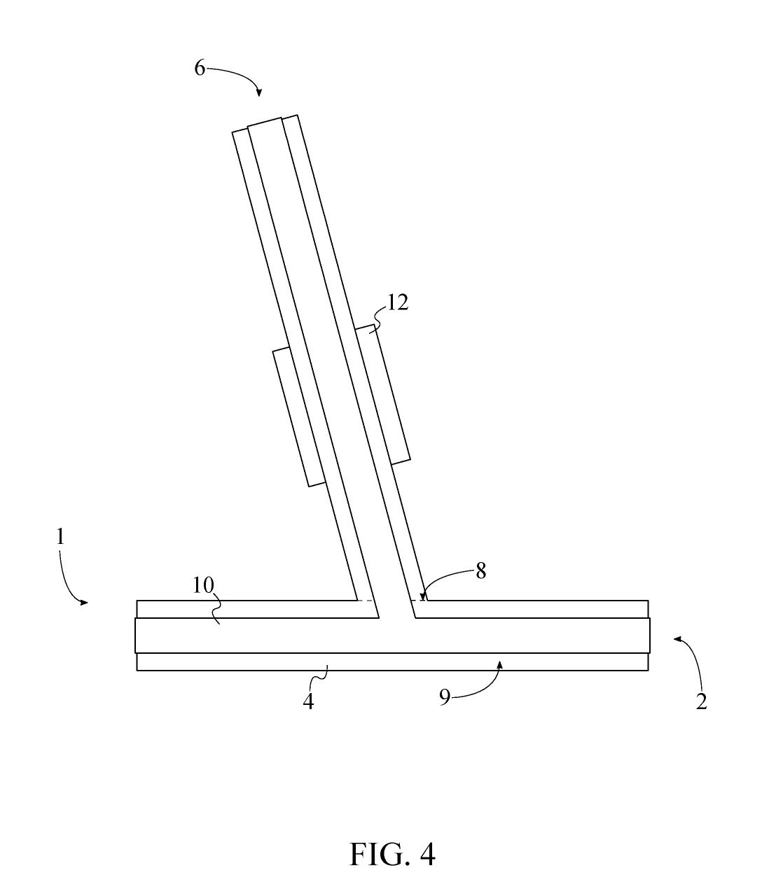

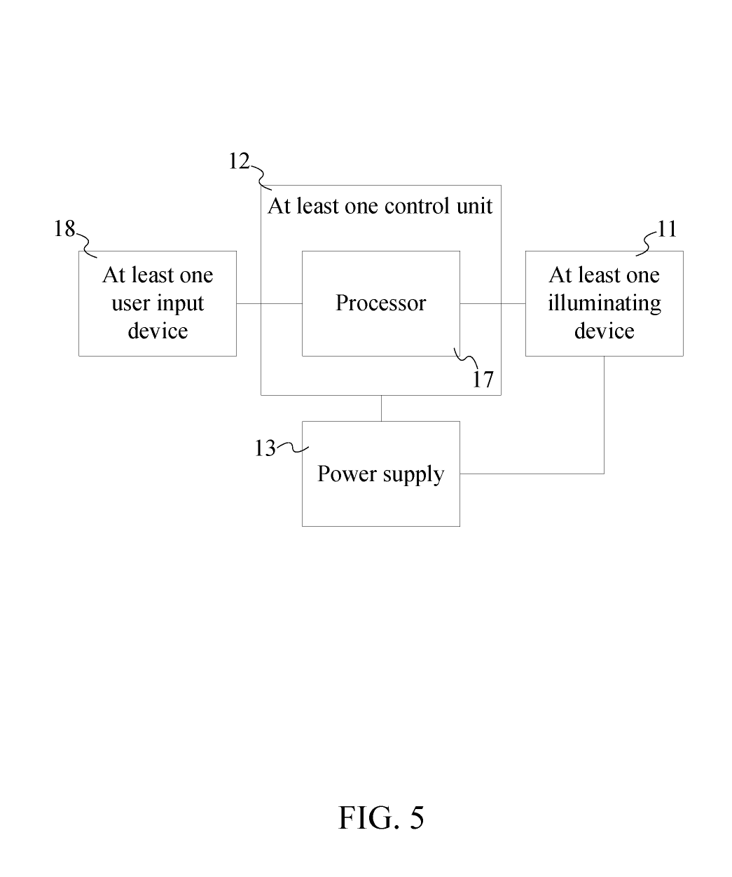

The present invention is an illuminating and reflective safety patrol band that is utilized to improve the user's visibility in low-light conditions. The present invention is shown in FIGS. 1-4 while electronic components of the present invention are shown in FIG. 5. The present invention comprises a wearable strap 1, at least one reflective strip 10, at least one illuminating device 11, and at least one control unit 12.

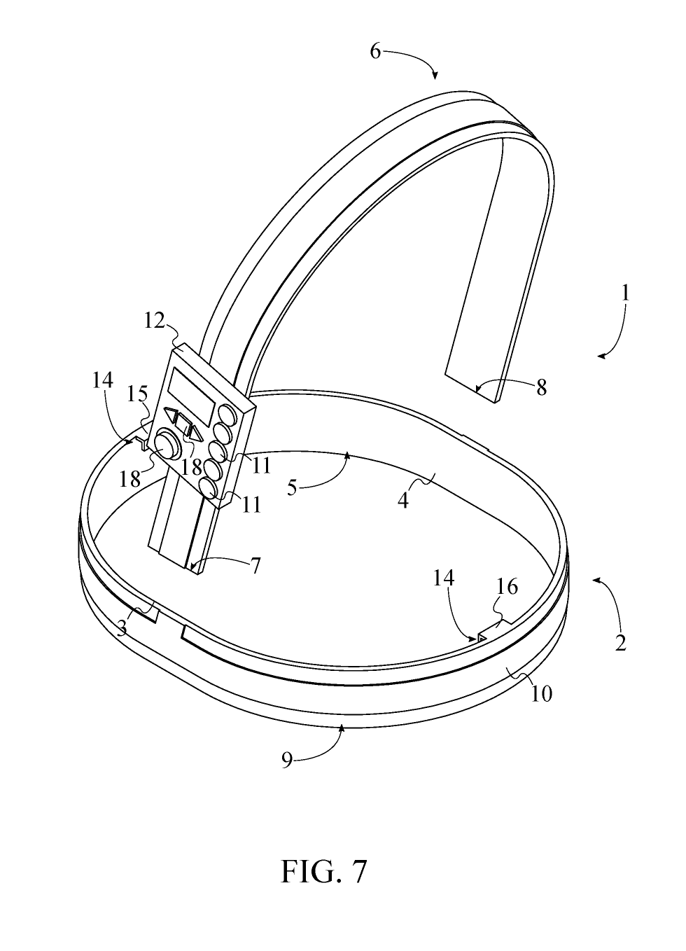

The wearable strap 1 is a garment that is worn over the user's clothing. The wearable strap 1 comprises a waist loop 2 and a cross strap 6. The waist loop 2 functions in a similar manner as a belt and is utilized to secure the wearable strap 1 to the user's waist. The waist loop 2 comprises an anterior portion 3 and a posterior portion 4 that correspond to the front of the user's body and the rear of the user's body, respectively. The cross strap 6 is utilized to secure the wearable strap 1 in place on the user's torso and prevent the wearable strap 1 from separating from the user's body. A first end 7 of the cross strap 6 is connected to the anterior portion 3 while a second end 8 of the cross strap 6 is connected to the posterior portion 4, opposite to the first end 7. The first end 7 and the second end 8 thus serve as two points of connection between the cross strap 6 and the waist loop 2. The first end 7 and the second end 8 are additionally positioned on the waist loop 2 in a manner such that the cross strap 6 is able to traverse from the anterior region of the user's body, over the user's shoulder, and to the posterior region of the user's body, securing the wearable strap 1 to the user's body. In the embodiment of the present invention shown in FIG. 7, the cross strap 6 is removable from the waist loop 2, enabling the present invention to be utilized as a belt-like garment for improving the user's visibility. Alternatively, the waist loop 2 and the cross strap 6 may be formed from a single continuous piece of material.

The at least one reflective strip 10 is utilized to reflect ambient light that is directed toward the user in order to passively improve the user's visibility. The at least one reflective strip 10 is superimposed upon the wearable strap 1 and as such is positioned on the wearable strap 1 to reflect light away from the user's body. The at least one reflective strip 10 may be a single continuous strip or multiple strips. Additionally, the specific design of the at least one reflective strip 10 may vary as well. For example, the at least one reflective strip 10 may include a web of reflective threads. The waist loop 2 and the cross strap 6 each comprise an outer face 9 that is the outward-facing surface of the waist loop 2 and the cross strap 6 when the wearable strap 1 is worn on the user's body. In the preferred embodiment of the present invention, the at least one reflective strip 10 is positioned on the outer face 9 of the waist loop 2 and the outer face 9 of the cross strap 6. This positions the at least one reflective strip 10 to reflect light away from the user's body.

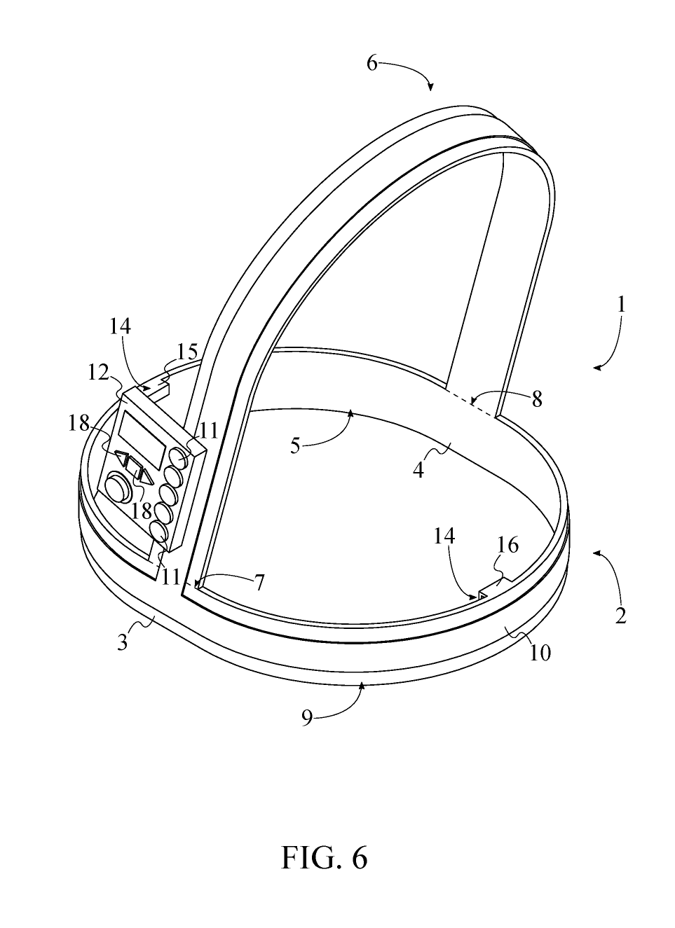

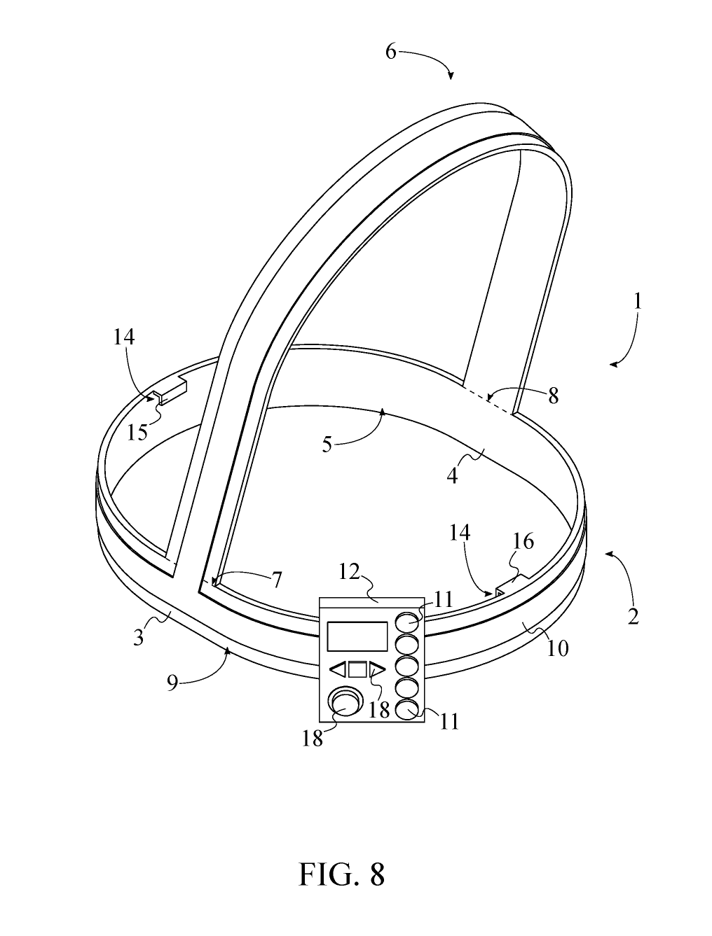

The at least one illuminating device 11 actively improves the user's visibility by producing illumination in the form of light. In the preferred embodiment of the present invention, the at least one illuminating device 11 is a light-emitting diode (LED). The at least one control unit 12 enables the user to manage the behavior and characteristics of the at least one illuminating device 11. For example, the user may adjust the brightness of the at least one illuminating device 11 as well as configure the at least one illuminating device 11 to blink, strobe, or change color through the at least one control unit 12. The at least one illuminating device 11 is externally positioned on the at least one control unit 12. This allows the at least one illuminating device 11 and the at least one control unit 12 to be contained within a single unit and enables the at least one illuminating device 11 to provide illumination from the external surface of the at least one control unit 12. The at least one control unit 12 is connected to the wearable strap 1, enabling the at least one illuminating device 11 to provide illumination to the wearable strap 1 when the wearable strap 1 is worn by the user. In the embodiment of the present invention shown in FIG. 6, the at least one control unit 12 is removable from the wearable strap 1. This allows the user to select the positioning of the at least one control unit 12 on the wearable strap 1 and additionally allows the present invention to be utilized without the at least one illuminating device 11 and the at least one control unit 12. In the embodiment of the present invention shown in FIGS. 1-4, the at least one control unit 12 is positioned on the cross strap 6 while in the embodiment of the present invention shown in FIG. 8, the at least one control unit 12 is positioned on the waist loop 2.

The present invention further comprises a power supply 13 that is utilized to provide electrical power to the electronic components of the present invention. The power supply 13 is electrically connected to the at least one control unit 12 and the at least one illuminating device 11 as shown in FIG. 5. The power supply 13 is thus able to provide electrical power to the at least one control unit 12 and the at least one illuminating device 11. In the preferred embodiment of the present invention, the power supply 13 is a rechargeable or replaceable battery that is positioned within the at least one control unit 12.

The present invention further comprises at least one securing fastener 14. The at least one securing fastener 14 is utilized to secure the wearable strap 1 to the user's clothing when the present invention is in use. The waist loop 2 comprises an inner face 5 that is the inward-facing surface of the waist loop 2 when the present invention is worn on the user's body. The at least one securing fastener 14 is positioned on the inner face 5 and may thus be clipped to the user's belt or the waist of the user's pants. In the preferred embodiment of the present invention, the at least one securing fastener 14 comprises a first securing fastener 15 and a second securing fastener 16. The first securing fastener 15 and the second securing fastener 16 are able to provide two points of contact between the waist loop 2 and the user's clothing in order to prevent the present invention from shifting while in use. The first securing fastener 15 and the second securing fastener 16 are offset from each other along the waist loop 2. Offsetting the first securing fastener 15 and the second securing fastener 16 from each other enables the first securing fastener 15 and the second securing fastener 16 to better stabilize the waist loop 2 on the user's clothing.

The present invention further comprises a processor 17 and at least one user input device 18. The processor 17 is able to process commands provided by the user through the at least one user input device 18. The at least one user input device 18 may include a button, a switch, or a similar means of inputting user commands including turning the at least one illuminating device 11 on or off and increasing or decreasing the brightness of the at least one illuminating device 11. The processor 17 is enclosed within the at least one control unit 12 and is thus protected from damage. The at least one user input device 18 is externally positioned on the at least one control unit 12 for convenient access by the user. As shown in FIG. 5, the processor 17 is electronically connected to the at least one user input device 18 and the at least one illuminating device 11. As such, user commands provided through the at least one user input device 18 are executed by the processor 17 and implemented on the at least one illuminating device 11.

Although the present invention has been explained in relation to its preferred embodiment, it is understood that many other possible modifications and variations can be made without departing from the spirit and scope of the present invention as hereinafter claimed.

What is claimed is:

1. An illuminating and reflective safety patrol band comprises:
a wearable strap;
at least one reflective strip;
at least one illuminating device;
at least one control unit;
the wearable strap comprises a waist loop and a cross strap;
the waist loop comprises an anterior portion and a posterior portion;
a first end of the cross strap being connected to the anterior portion;
a second end of the cross strap being connected to the posterior portion, opposite to the first end;
the at least one reflective strip being superimposed upon the wearable strap;
the at least one illuminating device being externally positioned on the at least one control unit; and
the at least one control unit being connected to the wearable strap.

2. The illuminating and reflective safety patrol band as claimed in claim 1 further comprises:
a power supply; and
the power supply being electrically connected to the at least one control unit and the at least one illuminating device.

3. The illuminating and reflective safety patrol band as claimed in claim 1 further comprises:
the waist loop and the cross strap each comprise an outer face; and
the at least one reflective strip being positioned on the outer face of the waist loop and the outer face of the cross strap.

4. The illuminating and reflective safety patrol band as claimed in claim 1 further comprises:
at least one securing fastener;
the waist loop comprises an inner face; and
the at least one securing fastener being positioned on the inner face.

5. The illuminating and reflective safety patrol band as claimed in claim 4 further comprises:
the at least one securing fastener comprises a first securing fastener and a second securing fastener; and
the first securing fastener and the second securing fastener being offset from each other along the waist loop.

6. The illuminating and reflective safety patrol band as claimed in claim 1 further comprises:
a processor;
at least one user input device;
the processor being enclosed within the at least one control unit;
the at least one user input device being externally positioned on the at least one control unit; and
the processor being electronically connected to the at least one user input device and the at least one illuminating device.

7. The illuminating and reflective safety patrol band as claimed in claim 1 further comprises:
the at least one control unit being removable from the wearable strap.

8. The illuminating and reflective safety patrol band as claimed in claim 1 further comprises:
the cross strap being removable from the waist loop.

9. The illuminating and reflective safety patrol band as claimed in claim 1 further comprises:
the at least one control unit being positioned on the cross strap.

10. The illuminating and reflective safety patrol band as claimed in claim 1 further comprises:
the at least one control unit being positioned on the waist loop.

11. An illuminating and reflective safety patrol band comprises:
a wearable strap;
at least one reflective strip;
at least one illuminating device;
at least one control unit;
a processor;
at least one user input device;
the wearable strap comprises a waist loop and a cross strap;
the waist loop comprises an anterior portion and a posterior portion;
a first end of the cross strap being connected to the anterior portion;
a second end of the cross strap being connected to the posterior portion, opposite to the first end;
the at least one reflective strip being superimposed upon the wearable strap;
the at least one illuminating device being externally positioned on the at least one control unit;
the at least one control unit being connected to the wearable strap;
the processor being enclosed within the at least one control unit;
the at least one user input device being externally positioned on the at least one control unit; and
the processor being electronically connected to the at least one user input device and the at least one illuminating device.

12. The illuminating and reflective safety patrol band as claimed in claim 11 further comprises:
a power supply; and
the power supply being electrically connected to the at least one control unit and the at least one illuminating device.

13. The illuminating and reflective safety patrol band as claimed in claim 11 further comprises:
the waist loop and the cross strap each comprise an outer face; and
the at least one reflective strip being positioned on the outer face of the waist loop and the outer face of the cross strap.

14. The illuminating and reflective safety patrol band as claimed in claim 11 further comprises:
at least one securing fastener;
the waist loop comprises an inner face; and
the at least one securing fastener being positioned on the inner face.

15. The illuminating and reflective safety patrol band as claimed in claim 14 further comprises:
the at least one securing fastener comprises a first securing fastener and a second securing fastener; and
the first securing fastener and the second securing fastener being offset from each other along the waist loop.

16. The illuminating and reflective safety patrol band as claimed in claim 11 further comprises:
the at least one control unit being removable from the wearable strap.

17. The illuminating and reflective safety patrol band as claimed in claim 11 further comprises:
the cross strap being removable from the waist loop.

18. The illuminating and reflective safety patrol band as claimed in claim 11 further comprises:
the at least one control unit being positioned on the cross strap.

19. The illuminating and reflective safety patrol band as claimed in claim 11 further comprises:
the at least one control unit being positioned on the waist loop.
